(19) United States
(12) Patent Application Publication
(10) Pub. No.: US 2011/0046238 A1
(43) Pub. Date: Feb. 24, 2011

(54) CALCIUM BASED CARRIER PARTICLES

(76) Inventors: Bruce A. Keiser, Plainfield, IL (US); Timothy S. Keizer, Aurora, IL (US); Brett M. Showalter, Wheaton, IL (US); Tiffany Bohnsack, Carol Stream, IL (US); James H. Adair, State College, PA (US); Mylisa Parette, Bellefonte, PA (US); Amy Knupp, State College, PA (US); Andrei S. Zelenev, Spring, TX (US); Jason R. Burney, Aurora, IL (US)

Correspondence Address: NALCO COMPANY, 1601 W. DIEHL ROAD, NAPERVILLE, IL, 60563-1198, US

(21) Appl. No.: 12/546,284

(22) Filed: Aug. 24, 2009

(51) Int. Cl. C09K 3/00; C07F 9/06; A01N 25/00; D06P 1/00

(52) U.S. Cl. 514/770; 564/15; 556/404; 252/387; 549/219; 252/301.16; 549/220; 548/414; 8/636

(57) ABSTRACT

The present invention relates to a method for forming a calcium-based carrier particle consisting of the calcium-based material, an active, with or without a surface modification, a stabilizing agent, and the related composition. The calcium-based particle is illustrated by the general formula Caₓ(PO₄)_{y}(OH)_{z}R and may also include a silica or silica oxide substituent. R is an active or actives such as an organic or inorganic molecule that includes markers, amines, thiols, epoxies, organosilicones, organosilanes, sulfates, and water soluble agents and, as needed, a surface modification, S, which may be either organic or inorganic. A stabilizing agent may be necessary to maintain dispersion of the particles in aqueous media. Examples of a surface modifying material and stabilizing agents are inorganic salts of aluminum and boron or organic materials such as organosilanes or low molecular weight polymers. As such, the particle can be used in a variety of applications including any of a variety of high temperature, at acidic, neutral, or basic pH, or pressure environments. The carrier particles have applications as diverse as papermaking, water treatment, chemical tracing, personal care, microbiological control, oil recovery, delivery of polymers, for example.

### FIELD OF THE INVENTION

The present invention relates to novel calcium-based carrier particles and methods for forming calcium-based particle compositions with an active or actives. The invention has particular relevance to the resultant calcium-based composition or composite composition, as well as sols formed therefrom. More specifically, the present invention relates to calcium-phosphate-based carrier compositions having one or more actives and methods of forming such compositions.

### BACKGROUND OF THE INVENTION

Targeted or objective-oriented delivery of actives is an ongoing challenge for consumer and industrial applications. In addition to the stability of actives in particular applications, storage and shipment problems are frequently encountered. Practical concerns including transportability of an active or maximizing the benefit of the active's capabilities often curtail or completely eviscerate its benefits. For example, storage and shipment of actives is problematic because of chemical, photochemical, or physical instability. Thus, solutions are needed to maximize and enhance the benefit of actives. Ideally, such solutions include incorporating actives into a particle designed and manufactured specifically to store and deliver actives to targeted sites. There exists a specific need for composition of matter(s) and associated method(s) of manufacture for such active-containing particles, which can store, carry, and/or deliver the active for a specified task or objective.

### SUMMARY OF THE INVENTION

The present invention accordingly relates to calcium-based particle compositions and their manufacture. In a preferred aspect, the particles are prepared with active(s), surface modifiers, or other additives or substituents as desired according to certain embodiments as herein described from (i) a combination of calcium and phosphate containing reactants and/or (ii) pre-existing calcium phosphate-based particle sols by further reaction with calcium and phosphate-containing reactants. According to an embodiment, resulting compositions yield aqueous dispersions of particles, which may contain a stabilizing agent.

### A. Compositions

The present invention provides for a composition comprising a formula of Caₓ(PO₄)_{y}(OH)_{z}Rₜ, wherein x is from 1 to 10, y is from 1 to 10, and z is from 0 to 20, wherein R is an active and t is from 0 to 10; optionally wherein the composition contains a stabilizing agent.

The present invention also provides for a composition comprising a formula of Caₓ(PO₄)_{y}(OH)_{z}RₜSₘ, wherein x is from 1 to 10, y is from 1 to 10, z is from 0 to 20, m is from 0 to 100, wherein R is an active with t from 0 to 10 and wherein S is a surface modifier or a stabilizing agent or a combination thereof.

The present invention also provides for a composition comprising a formula of Yₓ(X)_{y}(OH)_{z}RₜSₘ wherein x ranges from 1 to 10; y ranges from 1 to 10; z ranges from 0 to 20; t ranges from 0 to 10, and m ranges from 0 to 100; wherein R is an active; wherein S is a surface modifier or a stabilizing agent or a combination thereof; wherein X is an anion; and wherein Y is a calcium salt (e.g., Ca²⁺) or a combination of calcium salt and other cations.

The present invention also provides for a composition comprising a formula of Caₓ(PO₄)_{y}(OH)_{z}(SiO₂)ₖRₜSₘ, wherein x is from 1 to 10, y is from 1 to 10, z is from 0 to 20, k is from 0.001 to 32, t is from 0 to 10, and m is from 0 to 100; wherein R is an active; and wherein S is a surface modifier or a stabilizing agent or a combination thereof.

### B. Methods

The present invention provides for a method for synthesizing a calcium phosphate-based composition, the method comprising: (a) forming a first solution by mixing a calcium-containing compound and/or an active, wherein the active is one single active or a plurality of actives; (b) forming a second solution by mixing a phosphate-containing compound and/the active; (c) optionally forming a third solution containing the active and/or a base; (d) optionally adjusting the pH of the first, second, and/or the third solution to be from about 5 to about 12; and (e) combining the first solution and the second solution and optionally the third solution to form within a reaction media the calcium phosphate-based composition which comprises a general formula Caₓ(PO₄)_{y}(OH)_{z}Rₜ, wherein x is from 1 and 10, y is from 1 and 10, z is from 0 and 20, and wherein R is an active with t from 0 to 10.

The present invention also provides for a method for synthesizing a calcium phosphate-based composition, the method comprising: (a) forming a first solution by mixing a calcium-containing compound and/or an active, wherein the active is one single active or a plurality of actives; (b) forming a second solution by mixing a phosphate-containing compound, a silicon-containing compound, and/or the active; (c) optionally forming a third solution containing the active, a silicon-containing compound, and optionally a surface modifier or stabilizer or a base; (d) optionally adjusting the pH of the calcium-containing solution or the phosphate-containing solution or the third solution to be from about 5 to about 12; and (e) combining the first solution and the second solution and optionally the third solution to form within a reaction media the calcium phosphate-based composition which comprises a general formula Caₓ(PO₄)_{y}(OH)_{z}(SiO₂)ₖRₜ, wherein x is from 1 and 10, y is from 1 and 10, z is from 0 and 20, k is from 0.001 and 32, and wherein R is the active with t from 0 to 10.

### DETAILED DESCRIPTION OF THE INVENTION

The present invention relates to calcium-based particles and compositions and methods of forming calcium-based particles. The composition of the invention, also generally referred to as a calcium-based particle composition, can then be combined with additional particles in solution. In particular, the present invention relates to calcium-based particles containing one or more actives, methods of manufacturing such particles, and resultant compositions. Any of a variety of actives may be selected for use in the preparation of calcium-based particles of the current invention including organic and inorganic molecules. Essentially, an active will be any composition material that can be “carried” by the particle, where the composition material is known to perform a function such as whitening, coloration, dehydration, binding, biocidal action, and corrosion or scale reduction or inhibition. The particles may be used in a variety of industrial processes or end products, dependent upon the active being carried. The active or actives may be released upon the passage of time, a change in temperature, or change in environment.

### A. Compositions

The calcium-based particles have application in a variety of industries and uses. The uses are dependent upon the particular organic or inorganic active(s) selected. In particular, the calcium-based particles can be readily used in any of a variety of high temperature, acidic or basic pH, or pressure environments. The calcium-based particles provide sufficient protection from the environment such that the additive is delivered for a final use. As such, they have applications as diverse as papermaking, water treatment, chemical tracing, personal care (e.g., cosmetics, cosmeceuticals, or other cosmetically acceptable compositions), microbiological control, oil recovery, and down hole delivery of polymers and other agents, to name a few. The particles of the invention can also deliver agents having limited water solubility or stability due to chemical, photochemical, or physical instability.

A composition comprising a formula of Caₓ(PO₄)_{y}(OH)_{z}Rₜ, wherein x is from 1 to 10, y is from 1 to 10, and z is from 0 to 20, wherein R is an active and t is from 0 to 10; and optionally wherein the composition contains a stabilizing agent is disclosed.

Various actives can be formulated with the calcium phosphate containing composition. One of ordinary skill in the art could envision many different types of particles for delivery; specifically, for example, the type of active chosen by one of ordinary skill in the art is hinged to a desired function.

In one embodiment, the R group is associated with said composition by an association selected from the group consisting of at least one of the following: ionic bonding, covalent bonding, Van der Waals forces, encapsulation, inclusion, molecular tether (e.g., oligomeric, polymeric, or other linkage), and other suitable forces and methods.

In another embodiment, the active R is selected from the group consisting of at least one of the following: functional agents, markers, amines, thiols, epoxies, organosilicones, organosilanes, water soluble agents, and the reaction product of actives, biocides, and/or corrosion inhibitors.

In a further embodiment, the functional agents may contain one or more functional groups such as but not limited to: alcohols, aldehydes, or ketones and/or combinations thereof.

In another embodiment, the markers are various fluorophores or dyes.

In yet another embodiment, the markers are selected from the group consisting of at least one of the following: fluorescein, rhodamine B, fluorophores, fluorophane, tetrasodium 1, 3, 6, 8, pyrenetetra sulfonate, optical brighteners, indocyanine green, and indocarbocyanine.

In yet a further embodiment, the markers are selected from the group consisting of at least one of the following: fluorescein; rhodamine B; fluorophore; fluorophane; tetrasodium 1, 3, 6, 8, pyrenetetra sulfonate; indocyanine green; indocarbocyanine; optical brightening agents (OBAs); fluorescent whitening agents (FWAs); and organic and inorganic dyes such as acid dyes, reactive dyestuffs, direct dyestuffs, dye fixing agents, orange HE dyes, black HE dyes, and bi-functional reactive dyes.

In yet a further embodiment, the OBAs include but are not limited to at least one of the following: Optical Brightener CBS-X supplied by Hiebei Xingyu Chemicals; China, Leucophor® supplied by Clariant; Rothausstrasse 61; CH-4132 Muttenz 1, Switzerland; and Tinapol CBS-X supplied by Ciba Specialty Chemicals Corp., 4050 Premier Drive, High point, NC 27261.

In yet a further embodiment, the fluorescein and fluorescein derivatives include, without limitation at least one of the following: BDCECF; BCECF-AM; Calcien-AM; 5,(6)-carboxy-2′,7′-dichlorofuo-rescein; 5,(6)-carboxy-2′7′-dichlorofuorescein diacetate N-succinimidyl ester; 5,(6)-carboxyeosin; 5,(6)-carboxyeosin diacetate; 5,(6)-carboxyfluorescein; 5-carboxyfluorescein; 6-carboxyfluorescein; 5,(6)-carboxyfluorescein acetate; 5,(6)-carboxyfluorescein acetate N-succinimidyl ester; 5,(6)-carboxyfluorescein N-succinimidyl ester; 5(6)-carboxyfluorescein octadecyl ester; 5,(6)-carboxynaphthofluorescein diacetate; eosin-5-isothiocyanate; eosin-5-isothiocyanate diacetate; fluorescein-5(6)-carboxamidocaproic acid; fluorescein-5(6)-carboxamidocaproic acid N-succinimidyl ester; fluorescein isothiocyanate; fluorescein isothiocyanate isomer 1; fluorescein isothiocyanate isomer 2; fluorescein isothiocyanate diacetate; fluorescein octadecyl ester; fluorescein sodium salt; napthofluorescein; napthofluorescein diacetate; and N-octadecyl-N′-(5 fluoresceinyl) thiourea (F18).

In yet a further embodiment, organic dyes and pigments include but are not limited to at least one of the following: 18-dipropanoic acid; cyanine dyes; and derivatives, such as indocyanine green, indoine blue, PE-Cy 5, PE-Texas Red, propidium iodide, crystal violet lactone, patent blue VF, brilliant blue G or cascade blue acetyl azide.

In another embodiment, the amines are various organic nitrogen-containing compounds such as primary, secondary, tertiary and quaternary amines, the latter also referred to as quaternary ammonium compounds.

In a further embodiment, the amines can be aromatic, i.e. containing one or more aromatic groups as well as aliphatic amines.

In a further embodiment, the nitrogen-containing compound is preferably water-soluble or water dispersible.

In a further embodiment, the organic nitrogen-containing compounds usually have a molecular weight below 1,000 and contain up to 25 carbon atoms.

In a further embodiment, the amines contain one or more oxygen-containing substituents such as hydroxyl groups and/or alkyloxy groups.

In a further embodiment, the organic nitrogen-containing compounds may also include one or more amines. Examples include, but are not limited to, alkylamines, e.g. ethylamine or propylamine; secondary amines, e.g. dialkylamines such as diethylamine; dialkanolamines such as diethanolamine; and tertiary amines such as triethylamine or trialkanolamines such as triethanolamine. Examples of suitable quaternary amines are tetraalkanolamines such as tetraethanol ammonium hydroxide or N,N-dimethylethanolamine.

In another embodiment, the thiols are represented generally by the class of organic and inorganic compounds containing the thiol group having the general formula —B—(SH). Wherein B is a linear or branched group consisting of carbon atoms from 1 to 15 such as —(CH₂)n- where n is 1 to 15, and in particular 1 to 6, and most particularly, 3. Examples of other sulfur-containing compounds useful herein would include but are not limited to trimercapto-s-triazine and thiocarbamates.

In another embodiment, the epoxies of the present invention are generally a group of organic compounds that contain within the molecule an epoxide ring.

In a further embodiment, the epoxide is a cyclic ether with only three ring atoms, one of which is an oxygen atom, e.g. ethylene oxide, C₂H₄O, or glycidoxypropyltrimethoxysilane.

In another embodiment, the organosilanes or silane coupling agents are well known in the art and may be represented generally by R(₄₋ₐ)-SiXₐ wherein “a” may be from 1 to 3. The organo-functional group, R—, may be any aliphatic or alkene containing a functionalized group such as propyl, butyl, 3-chloropropyl and so on. X is representative of a hydrolysable alkoxy group, typically methoxy or ethoxy.

In a further embodiment, organosilanes are selected from the group consisting of at least one of the following: 3-glycidoxypropyl; 3-aminopropyl; dimethylaminopropyl; 3-thiopropyl; 3-iodopropyl; 3-bromopropyl; 3-chloropropyl; acetoxypropyl; 3-methacryloxypropyl; vinylpropyl; alkylcarboxylic acid; fluoresceinthioureapropyl; rhodaminethioureapropyl; hydroxybenzophenyl propyl ether; and mercaptopropyl silanes.

In another embodiment, the water-soluble agents of the present invention can be described as organic polymers having a molecular weight of from 100 to 1,000,000 containing functionalities such as amines, carboxylic acids, phosphonates, sulfonates or combinations thereof. Examples of water-soluble agents include but are not limited to polyacrylic acids, citric acid, and amino acids. The reaction products of silanes and other additives are also anticipated herein with an example of this type of material, but not meant as a limitation being the reaction product between aminopropylsilane and fluorescein isothiocyanate.

In another embodiment, the biocides target bacteria, mold, and fungi. For purposes of this disclosure, the term “biocide” includes any agent capable of controlling, reducing, inhibiting, or otherwise altering the growth pattern of bacteria, mold, fungi, the like, and combinations thereof.

In a further embodiment, the biocides are selected from the group consisting of at least one of the following: phenolics; chlorine containing and/or bromine containing oxidizing compounds; organometallics; organosulfur compounds; heterocyclics; and nitrogen-containing compounds.

In a further embodiment, the biocides are selected from the group consisting of at least one of the following: benzalkonium chlorides; dialkyldimethyl-ammonium chloride; trichloroisocyanurate; copper quinolinolate; methylenebisthiocyanate; zinc dimethyldithiocarbamate; and 2-(n-octyl)-4-isothiazolin-3-one.

In another embodiment, the corrosion inhibitors are selected from the group consisting of at least one of the following: chromates; molybdates; oxygen scavengers; and aliphatic organic amines.

In another embodiment, scale inhibitors are selected from the group consisting of at least one of the following: inorganic pyrophosphate; esters of polyphosphoric acid; esters of phosphonates, and organic polymers such as polymers or copolymers of acrylic or methacrylic acid.

The amount of active (R) formulated into the above formula can vary and will depend upon at least one of the following factors: function of the particle; system chemistry where it is applied; system parameters; solubility of the particle or the actives; stability of the particle or actives in the particular environment; regulatory issues; and other factors as determined by a skilled artisan.

The molar ratios or amount of each constituent of the composition can vary depending on the function to be performed by it. One of ordinary skill in the art could alter the molar ratios of each constituent atom so that a particular result can be achieved and can be done so without undue experimentation.

In one embodiment, the calcium to phosphate molar ratio is from 1 to 5.

In another embodiment, the content of hydroxide, z in formula, is from 0 to 20.

In another embodiment, the weight ratio of active or actives to the total calcium and phosphate is from 0.0001 to 1.

In another embodiment, the calcium phosphate is from 0.5 to 50 weight percent.

In another embodiment, the calcium to phosphate molar ratio is from 1:1 to 5:1

In another embodiment, the composition comprises from 0.5% to 50% by weight Ca₁₀(PO₄)₆ and 0.02% to 2% by weight active.

The composition can also contain one or more stabilizing agents. In one aspect, stabilizing agents are materials that are capable of bringing fine solid particles into a state of suspension as to inhibit or prevent their agglomerating or settling in a fluid medium.

In one embodiment, the stabilizing agents are selected from the group consisting of at least one of the following: organic phosphonates; polyacrylates and copolymers with compatible monomers; sulfonated polymers; polymaleates; and certain natural polymers such as tannins and lignins. These materials are available from several manufacturers under several trademarks. Some examples are Goodrite® polyacrylates and copolymers supplied by Goodrich Chemical Company, Dequest® organic phosphonates supplied by Monsanto Chemical Company, and Versa-TL® polysulfonates supplied by National Starch Corporation, to name a few.

The amount of stabilizing agent in said composition can vary and depends upon many factors that would be apparent to one of ordinary skill in the art.

In one embodiment, the stabilizing agent of said composition is from 0.0001 to 50 weight percent.

The particle size of the composition can be of various size and similar to other aspects of the composition, the size can vary depending on various factors such as the function of the composition and application for the composition.

In one embodiment, the composition has a surface area that ranges from about 5 m²/g to about 1,000 m²/g.

In another embodiment, the composition has pores in the range from about 5 Å to about 120 Å.

In another embodiment, the composition has a total pore volume from about 0.02 cc/g to about 1.0 cc/g, with particle size from about 5 nm to about 10 microns.

In another embodiment, the composition has a particle size that ranges from about 5 nm and about 10 microns.

In another embodiment, the composition has a particle size ranging from about 5 nm to about 200 nm.

In another embodiment, the composition has a particle size of about 20 nm.

The compositions can be in various chemical states that facilitate the application of the compositions for its intended purpose and/or synthesis of said compositions.

In one embodiment, the composition is a dispersion, emulsion, or microemulsion, wherein said composition that is an emulsion or microemulsion contains an immiscible liquid (e.g., oil).

In another embodiment, the composition is an aqueous dispersion having a pH selected from the group consisting of: from 5 to 12; from 6.5 to 8.5; and 7.

The compositions described above can also include a surface modifier.

In one embodiment, the composition is a composition comprising a formula of Caₓ(PO₄)_{y}(OH)_{z}RₜSₘ, wherein x is from 1 to 10, y is from 1 to 10, z is from 0 to 20, and m is from 0 to 100, wherein R is an active and t is from 0 to 10, and wherein S is a surface modifier or stabilizing agent or combination thereof.

In another embodiment, the surface modifier “S” is selected from the group consisting of at least one of the following: inorganic modifiers including at least one of the following aluminum, zirconium, titanium, zinc, cerium, boron, lithium, iron, salts of the foregoing; polymeric surface modifiers including at least one of the following polyamines, polyacrylates, polyethylene glycol, polyethylene oxide, polyethylene imines, poly quaternary amines, polyphosphonates, and polysulfonates; organic surface modifiers including at least one of the following: carboxylic acids, amines, phosphonates, organosilicones, organosilanes, glycols, nonionic surfactants, and quaternary amines.

In an alternative embodiment, the composition is a dispersion and may also contain other cations, such as M₂O, where M is alkali metal ion (e.g. Li, Na, K, etc.) and/or ammonium. These other cations may be present from trace amounts to up to about 1% by weight. The dispersions may have a pH of at least about 10, suitably at least about 9, preferably at least about 8.5. In another embodiment of this invention, the pH of the dispersion is from 5 to 12, and preferably from 7 to 9. The composition of this invention can further have positive, negative, or neutral charge.

In another embodiment, the composition will have diameters ranging from 3 nm to 10 microns and comprise from 0.5% to 50% by weight calcium phosphate and 0.02% to 2% by weight actives. In a further embodiment, the composition has a surface area ranging from 5 m²/g and 1000 m²/g, and a more specifically from 20 and 900 m²/g. In a further embodiment, the particle size of the composition is from 5 nm to 5 microns, and more particularly 10 nm to 2 microns. Preferably, the particles are about 20 nm. Further, the composition can be characterized by having an anionic, cationic or neutral surface charge dependent upon the surface modifier selected or the stabilizing agent or a combination thereof. In a further embodiment, the physical form of the particles may be crystalline, amorphous or a combination thereof. In a further embodiment, the base material of the composition, i.e. calcium phosphate, can be derived from soluble calcium and phosphate containing salts, hydroxyapitite, and combinations thereof. In a further embodiment, the composition is dispersed in water.

In another embodiment, the composition is a dispersion, specifically, an aqueous composition. In a further embodiment, the composition has a particle dimension being less than 10 microns, more preferably a dimension less than 1 micron, and most preferably one dimension in the colloidal range of less than 200 nm. In a further embodiment, the dispersions have a calcium phosphate content of at least about 0.5% by weight, but it is more suitable that the calcium content is within the range of from about 1% to 50% by weight, preferably from about 1% to 40% by weight, and more preferably from about 1% to 30% by weight.

In another embodiment, the composition is a sol, specifically, the composition has an average particle size below about 200 nm and preferably in the range of from about 3 to about 150 nm, more specifically, 5 and 100 nm, and more specifically, 10 and 30 nm. In a further embodiment, the particle size refers to the average size of the primary particles, which may be aggregated or non-aggregated. In yet a further embodiment, the specific surface area of the composition is suitably at least 5 m²/g calcium and preferably at least between 100 m²/g and 1000 m²/g. Generally, the specific surface area can be up to about 1,000 m²/g. In a preferred embodiment of this invention (e.g. as a retention and drainage aid), the specific surface area is within the range of from about 10 to 1,000 m²/g, preferably from about 50 to 300 m²/g. In another preferred embodiment of this invention, the specific surface area is within the range of from about 775 to 1,000 m²/g. The term “specific surface area,” as used herein, represents the average specific surface area of the calcium-based particles and is expressed as square meters per gram (m²/g) of calcium phosphate.

In another embodiment, the composition is a composition comprising a formula of Yₓ(X)_{y}(OH)_{z}RₜSₘ wherein x ranges from 1 to 10; y ranges from 1 to 10; z ranges from 0 to 20; t ranges from 0 and 10, and m ranges from 0 to 100; wherein R is an active; wherein S is a surface modifier or a stabilizing agent or a combination thereof; wherein X is an anion; and wherein Y is a calcium salt (e.g. Ca²⁺) or a combination of calcium salt and other cations.

In another embodiment, X is selected from the group consisting of salts of at least one of the following: phosphate, hydrogen phosphate, pyrophosphate, and carbonate.

In another embodiment, Y is a calcium salt and a combination of cations selected from the group consisting of at least one of the following: alkali metal cation, alkaline earth metals, actinide and lanthanide metals.

In another embodiment, the calcium salts are selected from the group consisting of at least one of the following: calcium hydroxide, calcium oxide, and water-soluble calcium salts.

In another embodiment, Y is a calcium constituent and X is a phosphate constituent at a molar ratio of calcium to phosphate of from 1 to 10, whose surface area ranges from 5 m²/g to 1000 m²/g, with pores ranging in size from 5 Å to 120 Å, and a total pore volume from 0.02 cc/g and 1.0 cc/g, and a particle size from 5 nm to 10 microns.

Any of the compositions described herein can also include a surface modifier.

In one embodiment, a composition comprising a formula of Caₓ(PO₄)_{y}(OH)_{z}(SiO₂)ₖRₜSₘ, wherein x is from 1 to 10, y is from 1 to 10, z is from 0 to 20, k is from 0.001 to 32, t is from 0 to 10, and m is equal to from 0 to 100; wherein R is an active; and wherein S is a surface modifier or a stabilizing agent or a combination thereof.

In another embodiment, x ranges from 1 to 10; y ranges from 1 to 10; z ranges from 0 to 20; t is from 1 and 10; R is selected from the group consisting of at least one of the following: surface modifiers, markers, amines, thiols, epoxies, organosilicones, organosilanes, water-soluble agents, the reaction product of actives, biocides, scale and corrosion inhibitors, and/or combinations thereof; and S is selected from the group consisting of: inorganic modifiers including at least one of the following aluminum, zirconium, titanium, zinc, cerium, boron, lithium, iron, salts of the foregoing; polymeric surface modifiers including at least one of the following polyamines, polyacrylates, polyethylene glycol, polyethylene oxide, polyethylene imines, poly quaternary amines, polyphosphonates, and polysulfonates; organic surface modifiers including at least one of the following: carboxylic acids, amines, phosphonates, organosilicones, organosilanes, glycols, nonionic surfactants, and quaternary amines.

### B. Methods of Manufacture of Calcium Phosphate Containing Compositions

Two generic formulas that fall within the scope of this disclosure are the following: Caₓ(PO₄)_{y}(OH)_{z}Rₜ and Caₓ(PO₄)_{y}(OH)_{z}(SiO₂)ₖRₜ. Other atoms can be associated with these formulations, but the following disclosure is sufficient to teach/guide a person of ordinary skill in the art as to how to make the calcium phosphate compositions and variants thereof.

The particles discussed herein and equivalents thereof can be made by at least one of the following synthesis methodologies disclosed below.

In one embodiment, a method for synthesizing a calcium phosphate-based composition comprises: (a) forming a first solution by mixing a calcium-containing compound and optionally an active, wherein the active is one single active or a plurality of actives; (b) forming a second solution by mixing a phosphate-containing compound and optionally an active, wherein the active is one single active or a plurality of actives; (c) optionally forming a third solution containing an active wherein the active is one single active or a plurality of actives and optionally a base and optionally a surface modifier or stabilizer; (d) optionally adjusting the pH of the first solution and/or the second solution to be from about 5 to about 12; and (e) combining the first solution and the second solution and optionally the third solution to form within a reaction media the calcium phosphate-based composition which comprises a general formula Caₓ(PO₄)_{y}(OH)_{z}Rₜ, wherein x is from 1 and 10, y is from 1 and 10, z is from 0 and 20, and R is the active with t from 0 to 100. The single active or plurality of active may be the same or different for each of the formulations herein described.

In another embodiment, the method of forming or synthesizing the calcium phosphate-based composition comprises: (a) forming a first solution by mixing a calcium-containing compound and optionally an active, wherein the active is one single active or a plurality of actives; (b) forming a emulsion or microemulsion by combining the calcium-containing solution one or more immiscible liquids and one or more emulsifiers with mixing; (c) forming a second solution by mixing a phosphate-containing compound and optionally an active, R, wherein the active is a single active or a plurality of actives; (d) optionally forming a second emulsion or microemulsion by combining the phosphate-containing solution with one or more immiscible liquids and one or more emulsifiers with mixing; (e) optionally forming a third solution containing an active wherein the active is one single active or a plurality of actives and optionally a base; (f) optionally forming a third emulsion or microemulsion by combining the third solution with one or more immiscible liquids and one or more emulsifiers with mixing; (g) optionally adjusting the pH of the first solution and/or the second solution to be from about 5 to about 12; (h) combining the first emulsion or micro emulsion and optionally the third emulsion or microemulsion with the second emulsion to form the calcium phosphate-based composition which comprises a general formula Caₓ(PO₄)_{y}(OH)_{z}Rₜ, wherein x is from 1 and 10, y is from 1 and 10, z is from 0 and 20, and R is the active with t ranging from 0 to 100.

In another embodiment, a combining at least one emulsion or microemulsion formed above (e.g., (b), (d), or (f)) with any combination of the remaining solutions or emulsions or microemulsions provided the combination consists of one calcium-containing solution or emulsion or microemulsion and one phosphate-containing solution or emulsion or microemulsion sufficient to form the calcium phosphate-based composition comprising the general formula Caₓ(PO₄)_{y}(OH)_{z}Rₜ, wherein x is from 1 and 10, y is from 1 and 10, z is from 0 and 20, and R is the active with t ranging from 0 to 100.

In an embodiment, the calcium phosphate-based composition includes a surface modifier. An exemplary process for forming an anionic calcium phosphate (CaP) solution with a surface modifier, or dispersant, preferably involves combining a calcium reactant solution and a phosphate reactant solution together in a vessel containing an aqueous heel of a selected surface modifier or dispersant. The solution is stirred for a period of time, preferably between 15 minutes to 60 minutes. This reaction yields an anionic CaP solution having a pH of between 6 and 10. Ultra-filtration may be used to further concentrate the CaP solution. Surface modification can be carried out either during particle synthesis or in a subsequent step. The surface modifiers are generally added in an amount equal to between 0.0001% and 50% by weight of the composition.

In another embodiment, the calcium-containing compound is a water-soluble calcium salt.

In another embodiment, the calcium-containing compound is selected from the group consisting of: calcium chloride; calcium hydroxide; calcium oxide; and combinations thereof.

In another embodiment, the calcium-containing compound can be a calcium salt and a combination of a single cation or plurality of cations selected from the group consisting of alkali metal cation, alkaline earth metals, actinide and lanthanide metals.

In another embodiment, the phosphate-containing compound is selected from the group consisting of: alkaline salts of phosphate, hydrogen phosphate, pyrophosphate, and carbonate; alkali salts of phosphate, hydrogen phosphate, pyrophosphate and carbonate; and combinations thereof.

In another embodiment, the active is selected from the group consisting of: fluorophores; optical brighteners; water soluble organic compounds; water insoluble organic compounds; surface modifiers; surface treatment agents; stabilizing agents; markers; amines; thiols; epoxies; organosilicones; biocides; scale inhibitors; corrosion inhibitors; indocyanine green; indocarbocyanine; water-solubilizing agents; any reaction product(s) thereof; and combinations thereof.

For example, in one method a fluorophore is reacted with a calcium phosphate-based composition and then incorporated into the calcium utilizing the “direct synthesis” technique. Typically, a urea link is formed between the dye and the calcium composition. One advantage of incorporating the fluorophore (or other dye) active in the calcium phosphate-based composition is to prevent self-quenching of the dye or active, as the dye is bound with the calcium and not allowed to interact with the environment or other dye molecules. As such, the incorporation of the dye protects it from interacting with detrimental species in solution or a process stream. This incorporation is important, as many additives present in a process stream may quench its fluorescence. Also, pH changes may influence the efficiency of the dye or active. By incorporating the active into a calcium phosphate-based particle, the active is protected from such external factors.

In another embodiment, the surface modifier is selected from the group consisting of: inorganic modifiers including salts of aluminum, zirconium, titanium, zinc, cerium, boron, lithium, iron; colloidal or polysilicate microgels; organic dispersants having anionic, cationic, or nonionic functional groups; and combinations thereof.

In another embodiment, the organic dispersant is selected from the group consisting of low molecular weight polymers and copolymers of organic phosphonates and acrylic acid; sulfonated polymers; polymaleates; natural polymers including tannins, lignins, citrates, and citric acids; glycine; alanine; leucine; serine; tyrosine; tryptophan; lysine; other natural and synthetic amino acids; polyethylene glycol; polyethylene oxide; polyamines; polyethylene imine; reaction products or polymers of the foregoing; and combinations thereof.

In another embodiment, the active is coupled to the calcium phosphate-based composition through a mechanism selected from the group consisting of: chemical bond, encapsulation, inclusion, or combinations thereof.

In another embodiment, the active is present in an amount from about 0.0001 wt % to about 50 wt %, based on the total weight of the calcium phosphate-based composition.

In another embodiment, the active is present in an amount from about 0.5 wt % to about 10 wt %, based on the total weight of the calcium phosphate-based composition.

In another embodiment, the method further comprises adjusting the calcium phosphate-based composition to have a pH from about 5 to about 12.

In another embodiment, the calcium phosphate-based composition has a continuous aqueous phase.

In another embodiment, the method further comprises separating the calcium phosphate-based composition from the reaction media thereby creating an essentially dry calcium phosphate-based composition.

In another embodiment, the method further comprises separating the calcium phosphate-based composition from the reaction media by centrifugation or azeotropic separation method (e.g., simple or displacement method and distillation).

In another embodiment, the method further comprises separating the calcium phosphate-based composition from the reaction media and dispersing the separated calcium phosphate-based composition in water.

In a further embodiment, the reaction media includes from about 0.5 wt % to about 90 wt % or from about 0.5 wt % to about 50 wt % of the calcium phosphate-based composition.

In another embodiment, the reaction media includes from about 0.75 wt % to about 10 wt % of the calcium phosphate-based composition.

In another embodiment, the method further comprises combining the first solution and the second solution and optionally the third solution in situ via a mixing chamber. Examples of such mixing chambers are disclosed in U.S. patent Ser. No. 11/339,169, “Method and Arrangement for Feeding Chemicals into a Process Stream,” (available from Nalco Company in Naperville, Ill.) and the Ultra Turax, model no. UTI-25 (available from IKA® Works, Inc. in Wilmington, N.C.). It is envisioned that any suitable reactor or mixing device/chamber may be utilized in the method of the invention.

In another embodiment, the method further comprises combining the first solution and the second solution and optionally the third solution with mixing yielding a Reynolds Number greater than or equal to about 2,000, to form the calcium phosphate-based composition.

In another embodiment, the method further comprises combining the first solution with the second solution and optionally with the third solution under transitional flow conditions, i.e. Reynolds Numbers between approximately 2,000 and 4,000, to form the calcium phosphate-based composition.

In another embodiment, the method further comprises combining the first solution with the second solution and optionally with the third solution under turbulent flow conditions, i.e. Reynolds Numbers greater than or equal to about 4,000, to form the calcium phosphate-based composition.

In another embodiment, the method further comprises combining the first solution with the second solution and optionally with the third solution using such mixing techniques as controlled-double, triple or quadruple jet precipitation, to form the calcium phosphate-based composition. (see reference Colloid and Surface Chemistry, by E. E. Shchukin, A. V. Pertsov, E. A. Amelina, and A. S. Zelenev, Elsevier Publisher, Amsterdam, The Netherlands, 2001, pages 308-311).

As stated above the generic formula can also have a silica atom. In an embodiment, the method of making a composition containing silica contains the following steps.

In one embodiment, a method for synthesizing a calcium phosphate-based composition comprises: (a) forming a first solution by mixing a calcium-containing compound and an active, wherein the active is one single active or a plurality of actives; (b) forming a second solution by mixing a phosphate-containing compound, a silicon-containing compound, and the active; optionally forming a third solution containing the active and/or (c) optionally adjusting the pH of the first solution and/or the second solution to be from about 5 to about 12; and (d) combining the first solution and the second solution and optionally the third solution to form within a reaction media the calcium phosphate-based composition which comprises a general formula Caₓ(PO₄)_{y}(OH)_{z}(SiO₂)ₖRₜ, wherein x is from 1 and 10, y is from 1 and 10, z is from 0 and 20, k is from 0.001 and 32, and R is the active with t ranging from 0 to 100.

In an embodiment, a method for synthesizing a calcium phosphate-based composition comprises: (a) forming a first solution by mixing a calcium-containing compound and an active, wherein the active is one single active or a plurality of actives; (b) forming a second solution by mixing a phosphate-containing compound, a silicon-containing compound, and the active; (c) forming a third solution by mixing one or more immiscible liquids with one or more emulsifiers; (d) optionally adjusting the pH of the first solution and/or the second solution to be from about 5 to about 12; (e) combining the second solution with the third solution to form an emulsion of the second solution; (f) combining the first solution and the emulsion of the second solution to form the calcium phosphate-based composition which comprises a general formula Caₓ(PO₄)_{y}(OH)_{z}(SiO₂)ₖRₜ, wherein x is from 1 and 10, y is from 1 and 10, z is from 0 and 20, k is from 0.001 and 32, and R is the active with t ranging from 0 to 100.

In another embodiment, the immiscible liquid is an inert hydrocarbon, vegetable-derived oil, and/or combinations thereof.

In another embodiment, the emulsifier is selected from the group consisting of: sorbitan fatty acid esters, polyoxyethylene sorbitan fatty acid esters, polyoxyethylene alcohols, and combinations thereof. The emulsifier used as known in the art as the ester of a fatty acid and a water-soluble alcohol selected from the group consisting of fatty acid methyl ester oils, soya oil, methylated soya oil, ethylated soya oil, methyl soyate, ethyl soyate, methyl palmitate, methyl stearate, methyl oleate, methyl linolate, methyl linolenate, laurate-based oils, castro oil, linseed oil, coconut oil, corn oil, cottonseed oil, neatsfoot oil, olive oil, palm oil, peanut oil, rapeseed oil, safflower oil, sesame seed oil, sperm oil, sunflower oil, tall oil, tallow, and combinations thereof. Further, the emulsifier may be the ester of a fatty acid and water-soluble alcohol selected from the group of methyl and ethyl esters of C₁₆-C₁₈ fatty acids and/or combinations thereof. Other emulsifiers can be selected from the group consisting of polyoxyalkylene modified block copolymer, a polyisobutylene derivative with polyoxyalkene end groups and/or combinations thereof. Additionally, low HLB emulsifiers may be selected from the group consisting of sorbitan fatty acid ester, sorbitan oleic acid ester and combinations thereof. Also, high HLB emulsifiers may be used selected from the group consisting of polyoxyethylene sorbitan laurate, polyoxyethylene sorbitan palmitate, polyoxyethylene sorbitan stearate, polyoxyethylene sorbitan oleate, and combinations thereof.

In another embodiment, the emulsifier has an HLB from about 2 to about 14.

In another embodiment, the method of forming the calcium phosphate-based composition includes forming an emulsion including the first and/or second solution and the third solution.

In another embodiment, forming the calcium phosphate-based composition includes forming a water-in-oil dispersion.

In a representative reaction scheme, the calcium phosphate-based composition is formed in essentially two parts and is a direct synthesis technique. The reaction is initiated by reacting at ambient conditions a calcium precursor with an active and a phosphate. Any of a variety of calcium precursor compositions as described herein may be used. Generally, calcium chloride is preferred. The calcium containing solution is first added to vessel in an amount equal to between 2% and 30% by weight of the starting composition. Mixed with the calcium composition is at least one active. Additionally, the stabilizing agent may be added at this point. The active or actives are added in an amount equal to between 0.02% and 2%. This reaction preferably takes place in water, which is present in an amount equal to between 10% and 90% by weight of the solution. Optionally, a silicon-containing reactant such as acid sol, solution may be included. Acid sol can also be optionally added. Typically, temperatures are reduced to about 0° C. to prevent gelation of the reaction mixture during synthesis. To a second vessel, a phosphate, (e.g., Na₃PO₄), is added in an amount equal to between 0.1% and 30% by weight of the starting composition. The phosphate is added to water, which will contain an amount of a catalyst, such as NaOH. The catalyst can be selected from any of a variety of bases known in the art including NaOH, KOH, and NH4OH, and is present in an amount equal to between 0.1% and 5% by weight of the mixture. The stabilizing agent may be added at this stage as well. The two solutions can then be pumped into a mixer. The reaction can be performed as part of a batch process, and is allowed for a period of time, upwards of 24 hours, sufficient to bond the active to the calcium derivative carrier. Alternatively, the reaction may proceed continuously. In some embodiments, the reaction is an integral part of an industrial process and proceeds, for example, in situ and in conjunction with the process.

In an embodiment, the initial reaction product of the active-containing calcium phosphate-based composition is subjected to further processing. For instance, added to the calcium-based precursor composition may be an additional amount of active or actives. The temperature at which this is done, as well as the concentration and rate, are controlled so as to result in the composition, particle size, and concentration desired. The composition can be concentrated by any of a variety of methods known in the art, such as ultra-filtration. In this manner, the concentration of active(s), particle size, and composition of the particles can be further tuned and controlled. Moreover, smaller primary particles may be grown with the active or dye coupled to the calcium derivative in an acid sol composition. Then secondly, more acid sol is optionally added to coat the primary particles.

In order to simplify shipping and reduce transportation costs, it is generally preferable to ship high concentration dispersions. It is possible and usually preferable to dilute and mix the composition of the invention (e.g., as a sol or dispersion) with water to substantially lower calcium content prior to use. For example, water may be added to adjust calcium content to at least about 0.05% by weight and preferably within the range of from about 0.05% to 5% by weight, in order to improve mixing with the furnished components. The viscosity of the composition may vary depending on, for example, the calcium content of the dispersion. Usually, the viscosity is at least 5 centipoise (cP), normally within the range of from about 5 to 40 cP, suitably from about 6 to 30 cP, and preferably from about 7 to 25 cP. The viscosity, which is suitably measured on dispersions having a calcium content of at least 10% by weight, can be measured by means of known technique, such as using a Brookfield LVDV II+ viscosimeter. Preferred dispersions of this invention are stable. In summary, these dispersions, when subjected to storage or aging for one month at 20° C. in dark and non-agitated conditions, typically exhibit only a small increase in viscosity, if any.

The following examples are intended to be illustrative of the present invention and to teach one of ordinary skill how to make and use the invention. These examples are not intended to limit the scope of the invention or the claims in any way.

### Example 1

The present example relates to a method for synthesizing a calcium phosphate particle. Synthesis of 1.4% calcium phosphate particles was done with 0.75% polyacrylic acid using a continuous high shear mixer. The formula was as follows:

| Components | Wt % |
|---|---|
| 31% CaCl₂ Solution | 5.220 |
| 42.5% polyacrylic acid (mw ~5,000) | 1.780 |
| Water | 43.000 |
| Na₃PO₄ | 3.320 |
| 50% NaOH solution | 0.350 |
| Water | 46.330 |

The continuous method was done as follows. In a first vessel, the CaCl₂, polyacrylic acid, and water were mixed under ambient conditions to insure a homogenous solution. In a second container, the Na₃PO₄, NaOH, and water were mixed until all of the Na₃PO₄ had dissolved. The two solutions were then pumped into an Ika ultra-turrax (T-25 Basic) high shear mixer in which the mixing head had been modified by the addition of an extra inlet port. Each pump delivered the two solutions at a rate of 1.8 L/min. The mixing head was running at 9,500 RPM. The particles, which had formed in the mixing chamber, were collected at the exit of the mixing head. The size of the particles was approximately 100 nm.

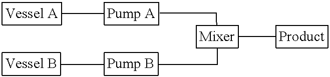

As such, calcium phosphate particles, which can be used as carriers were produced.

### Example 2

Next, a batch process for providing calcium phosphate (CaP) with a stabilizing agent and an optical brightening agent (OBA) was practiced.

To a 15 mL solution of 500 mM CaCl₂ was added 10 mL of a 5.3 mM (3 mg/mL) solution of the disodium salt of Tinopal CBS-X (OBA) in DI water drop-wise with stirring. A fine yellow precipitate formed immediately whereby the OBA was coupled to the CaCl₂. Next, a solution of 0.78 g of 48% sodium polyacrylic acid (PAA) dissolved in 15 mL of 300 mM Na₂HPO₄/467 mM NaOH was added drop-wise with vigorous stirring over the course of two minutes to the CaCl₂ OBA coupled product. After stirring an additional five minutes at ambient temperature, the product was allowed to stand whereupon a yellow precipitate slowly settled out. The resulting product was 1.8% CaP, 0.7% PAA, and 0.07% Tinopal CBS-X.

### Example 3

0.78 g of 48% sodium-PAA was added to a 15 mL solution of 500 mM CaCl₂ and stirred to dissolve. To this was added 10 mL of a 10.6 mM (6 mg/mL) solution of the disodium salt of Tinopal CBS-X in DI water drop-wise with stirring. A fine yellow precipitate formed immediately. This was followed by the drop-wise addition of 15 mL of 300 mM Na₂HPO₄/467 mM NaOH over the course of two minutes. After stirring an additional five minutes at ambient temperature, the product was allowed to stand whereupon a yellow precipitate slowly settled out. The resulting product was 1.8% CaP, 0.7% PAA, and 0.14% Tinopal CBS-X.

### Example 4

A batch process for forming an anionic CaP with dispersant was practiced. A solution of CaCl₂ and a solution with Na₂HPO₄ and NaOH were added into a 250 mL beaker containing an aqueous heel of a selected dispersant (PAA) and stirred for 30 minutes. The resulting anionic CaP solution pH was between 6 and 10. Ultra-filtration was used to further concentrate the calcium phosphate solutions. Table A presents the reaction parameters and pH of the resulting CaP solution.

TABLE A
Reaction parameters for formation of CaP

| | | % | | | PAA | 0.5 M | 0.3 M | 50% | |
|---|---|---|---|---|---|---|---|---|---|
| | % | dispersant | | pH of CaP | (48%) | CaCl₂ | Na₂HPO₄ | NaOH | H₂O |
| Sample | CaP | (PAA) | Ca:PO₄ | solution | g | mL | mL | g | g |
| A | 1.00 | 0.54 | 1.67:1 | 7.20 | 40.65 | 750 | 750 | 27.0 | 2070 |
| B | 1.00 | 0.75 | 1.67:1 | 7.00 | 56.50 | 750 | 750 | 30.0 | 2000 |
| C | 1.40 | 0.50 | 1.67:1 | 7.42 | 1.80 | 50 | 50 | 1.60 | 69.81 |
| D | 1.40 | 0.75 | 1.67:1 | 7.16 | 2.71 | 50 | 50 | 1.80 | 68.70 |
| E | 1.40 | 1.00 | 1.67:1 | 7.32 | 3.61 | 50 | 50 | 2.15 | 67.45 |
| F | 1.40 | 1.50 | 1.67:1 | 7.55 | 5.41 | 50 | 50 | 2.80 | 65.00 |
| G | 1.40 | 2.00 | 1.67:1 | 7.90 | 7.22 | 50 | 50 | 3.50 | 62.49 |

Table A illustrates, the resulting pH of seven CaP sample solutions was measured. CaCl₂ and Na₂HPO₄ were added in equal parts to the reaction at either 750 mL (samples A and B) or 50 mL (samples C-G). The amount of stabilizing agent (PAA), base (NaOH), and water added to the reaction varied across the samples, keeping the molar ratio of Ca:PO₄ steady at 1.67:1. The pH of the resulting CaP solution varied from 7.00 (sample B) to 7.90 (sample G).

Select samples of the CaP solution were then dried at a temperature of 135° C. and washed in order to obtain surface area measurements as determined by BET (Brunauer-Emmett-Teller) nitrogen adsorption. This is a standard technique for determining specific surface area, and is described in numerous texts including Journal of the American Chemical Society, Volume 60, Page 309, (1938). Surface area measurements for the select samples are presented in Table B.

TABLE B
Surface area results for selected samples

| | Sample C | Sample D |
|---|---|---|
| BET | Dried 135° C., washed | Dried 135° C., washed |
| Surface Area (m²/g) | 160.2 | 159.90 |
| Pore Volume (cc/g) | 0.2175 | 0.2440 |
| Pore Size (Å) | 54.32 | 61.0 |

### Example 5

This example illustrates a batch process for anionic CaP with dispersant and SiO₂. A flask contained 62 mL of H₂O, 1.08 g of a 12.8% colloidal silica solution and 1.5 g of 42.5% polyacrylic acid (PAA). A solution of 70 mL of a 0.1 M CaCl₂ and a solution of 42 mL 0.1 M Na₂HPO₄ and 0.32 g 50% NaOH were added to the flask over 15 minutes. The average particle size by DLS was 44.3 nm and pH=7.5.

### Example 6

This example illustrates a batch process for CaP with OBA and SiO₂. A flask contained 160 mL of H₂O, 10.8 g of a 12.8% colloidal silica solution and 0.35 mL of 26% OBA solution. A solution of 180 mL of a 0.1 M CaCl₂ and a solution of 108 mL 0.1 M Na₂HPO₄ and 1.1 g 50% NaOH were added to the flask over 45 minutes. The pH of the solution was 8.5. The solution was centrifuged and washed with water to remove excess OBA and salt.

### Example 7

This example illustrates a batch process for forming CaP with an OBA. In a flask 160 mL of H₂O and 0.35 mL of 26% OBA solution were mixed to form an OBA solution. Next, a solution of 180 mL of a 0.1 M CaCl₂ and a solution of 108 mL 0.1 M Na₂HPO₄ and 0.9 g 50% NaOH were added to the flask containing the OBA solution over a time period of 45 minutes. The pH of the solution was 8.0. The solution was centrifuged and washed with water to remove excess OBA and salt. Resultingly, a CaP/OBA precipitate was formed.

### Example 8

This example illustrates a batch synthesis of cationic CaP with dispersant. To a beaker were added 9.13 g of DL-lysine monohydrochloride, 6.04 g of 6-aminocaproic acid, and 50 mL of 1M Ca(NO₃)₂ solution. The pH of the solution was raised from 6.77 to 9.06 with concentrated ammonium hydroxide. To this solution was added 50 mL of a 0.33M (NH₄)₂HPO₄ solution, drop-wise with stirring. A white solid precipitated immediately. The reaction mix was stirred for 5 hours and then poured into a bottle. Overnight the white solid dispersed, giving a slightly cloudy solution. The average particle size by DLS was 32.8 nm and pH=9.0.

### Example 9

This example illustrates a continuous synthesis method of cationic CaP with dispersant. A solution of 182.68 g of DL-lysine monohydrochloride, 35.60 g of 50% NaOH, 143.00 g of CaCl₂.2H₂O, and 544.15 g of water, and a solution of 43.70 g of (NH₄)₂HPO₄ and 767.8 g of water were co-fed into a modified high shear mixer. A white slurry was collected from the outlet of the high shear mixture. Overnight the precipitated particles dispersed, giving a clear, light yellow brown solution. The average particle size by DLS was 34.9 nm and pH was 8.7.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements and all numerical values should be interpreted as including the phrase “about.” Moreover, all ranges disclosed herein are to be understood to encompass any and all subranges (including all fractional and whole values) subsumed therein.

Any weight percentages should be interpreted as being based upon total solution weight or based upon constituent molecules in the solutes of the solution. For example, 1 percent active is 1 gram per 100 grams total solution weight or 1 gram per 100 grams of the solutes.

Furthermore, the invention encompasses any and all possible combinations of some or all of the various embodiments described herein. Any and all patents, patent applications, scientific papers, and other references cited in this application, as well as any references cited therein and parent or continuation patents or patent applications, are hereby incorporated by reference in their entirety. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The invention is claimed as follows:

1. A composition comprising a formula of Caₓ(PO₄)_{y}(OH)_{z}Rₜ, wherein x is from 1 and 10, y is from 1 and 10, and z is from 0 and 20, wherein R is an active with t is from 0 to 10; and optionally wherein the composition contains a stabilizing agent.

2. The method of claim 1, wherein said composition is a dispersion, emulsion, or microemulsion, wherein said composition that is an emulsion or microemulsion contains an immiscible material.

3. The composition of claim 1, wherein said R is selected from the group consisting of at least one of the following: functional agents, markers, amities, thiols, epoxies, organosilicones, organosilanes, water soluble agents, and the reaction product of actives, biocides, and/or corrosion inhibitors.

4. The composition of claim 1, wherein the calcium to phosphate molar ratio is from 1 to 5; optionally the content of hydroxide, value of z is from 0 to 20; and optionally the weight ratio of R to the total calcium and phosphate is 0.0001 to 1.

5. The composition of claim 1, wherein the stabilizing agent is from 0.0001 to 50 weight percent.

6. The composition of claim 1, wherein the calcium phosphate is from 0.5 to 50 weight percent.

7. The composition of claim 1, wherein the composition includes the following parameters: surface area ranges from about 5 m²/g to 1,000 m²/g; optionally containing pores in the range from 5 Å to 120 Å; and optionally a total pore volume from 0.02 cc/g to 1.0 cc/g, with a particle size from 5 nm to 10 microns.

8. The composition of claim 3, wherein the markers are selected from at least one of the following: fluorophore; fluorescein and/or fluorescein derivatives; rhodamine B; fluorophane; tetrasodium 1,3,6,8-pyrenetetra sulfonate; indocyanine green; indocarbocyanine; optical brighteners; fluorescent whitening agents; acid dyes; reactive dyestuffs; direct dyestuffs; dye fixing agents; orange HE dyes; black dyes; and bifunctional reactive dyes.

9. The composition of claim 1, wherein the composition is an aqueous dispersion having a pH selected from the group consisting of: from 5 to 12; from 6.5 to 8.5; and 7.

10. The composition of claim 1, wherein the composition has a particle size ranging from 5 nm to 10 microns.

11. The composition of claim 1, wherein the calcium to phosphate molar ratio is from 1 to 5.

12. The method of claim 1, wherein said R is associated with said composition by an association selected from the group consisting of at least one of the following: ionic bonding, covalent bonding, Van der Waals forces, encapsulation, and inclusion.

13. The composition of claim 1, wherein the composition comprises from 0.5% to 50% by weight Ca₁₀(PO₄)₆ and 0.02% to 2% by weight R.

14. The composition of claim 1, wherein the composition has a surface area ranging from 30 about m²/g to about 400 m²/g and a particle size of from 10 nm to 30 nm.

15. The composition of claim 1, wherein the composition has a particle size ranging from about 5 nm to about 200 nm.

16. The composition of claim 1, wherein the composition has a particle size of about 20 nm.

17. The composition of claim 1 wherein the x ranges from 1 to 10, y ranges from 1 to 10, and z ranges from 0 to 20.

18. A composition comprising a formula of Caₓ(PO₄)_{y}(OH)_{z}RₜSₘ, wherein x is from 1 to 10, y is from 1 to 10, z is from 0 to 20, t is from 0 to 10, and m is from 0 to 100, wherein R is an active and wherein S is a surface modifier or a stabilizing agent or a combination thereof.

19. The composition of claim 18, wherein said S is selected from the group consisting of inorganic modifiers including at least one of the following: aluminum, zirconium, titanium, zinc, cerium, boron, lithium, iron, gallium, lanthanides, actinides, and salts of the foregoing; polymeric surface modifiers including at least one of the following: polyamines, polyacrylates, polyethylene glycol, polyethylene oxide, polyethylene imines, poly quaternary amines, polyphosphonates, and polysulfonates; organic surface modifiers including at least one of the following: carboxylic acids, amines, phosphonates, organosilicones, organosilanes, glycols, nonionic surfactants, and quaternary amines.

20. The composition of claim 18, wherein mole ratio of S to total calcium and phosphate is from 0 to 50.

21. The composition of claim 18, wherein the x ranges from 1 to 10, y ranges from 1 to 10, z ranges from 0 to 20, and m ranges from 0.01 to 100.

22. A composition comprising a formula of Yₓ(X)_{y}(OH)_{z}RₜSₘ wherein x ranges from 1 and 10; y ranges from 1 and 10; z ranges from 0 and 20, t ranges from 0 and 10, and m ranges from 0 and 100; wherein R is an active; wherein S is a surface modifier or a stabilizing agent or a combination thereof; wherein X is an anion; and wherein Y is a calcium salt or a combination of calcium salt and other cations.

23. The composition of claim 22, wherein X is an anion selected from the group consisting of salts of at least one of the following: phosphate, hydrogen phosphate, pyrophosphate, and carbonate.

24. The composition of claim 22, wherein Y is a calcium salt and a cation selected from the group consisting of at least one of the following: alkali metal cation, alkaline earth metals, actinide and lanthanide metals.

25. The composition of claim 22, wherein the calcium salt is selected from the group consisting of at least one of the following: calcium hydroxide, calcium oxide, and water soluble calcium salts.

26. The composition of claim 22, wherein Y is a calcium constituent and X is a phosphate at a molar ratio of calcium to phosphate of from 1 to 10 whose surface area ranges from 5 m²/g to 1,000 m²/g, with pores ranging in size from 5 Å to 120 Å, and a total pore volume from 0.02 cc/g to 1.0 cc/g, and a particle size of from 5 nm to 10 microns.
